(19) United States
(12) Patent Application Publication
(10) Pub. No.: US 2023/0402065 A1
(43) Pub. Date: Dec. 14, 2023

(54) GENERATING TITLES FOR CONTENT SEGMENTS OF MEDIA ITEMS USING MACHINE-LEARNING

(71) Applicant: Google LLC, Mountain View, CA (US)

(72) Inventors: Chenjie Gu, Mountan View, CA (US); Wei-Hong Chuang, Mountain View, CA (US); Min-Hsuan Tsai, San Jose, CA (US); Jianfeng Yang, Mountain View, CA (US); Keren Gu-Lemberg, San Francisco, CA (US); Flora Xue, Mountain View, CA (US); Shubham Agrawal, Mountainview, CA (US); Yuzhu Dong, Mountainview, CA (US); Ji Zhang, Mountainview, CA (US); Mahdis Mahdieh, Los Altos, CA (US); Gagan Bansal, Sunnyvale, CA (US); Kai Chen, Brisbane, CA (US)

(21) Appl. No.: 17/835,550

(22) Filed: Jun. 8, 2022

(51) Int. Cl. G11B 27/10; G11B 27/34; G06F 3/0481; G06F 3/04842

(52) U.S. Cl. CPC G11B 27/102; G11B 27/34; G06F 3/0481; G06F 3/04842

(57) ABSTRACT

Methods and systems for predicting titles for contents segments of media items at a platform using machine-learning are provided herein. A media item is provided to users of a platform, the media item having a plurality of content segments comprising a first content segment and a second content segment preceding the first content segment in the media item. The first content segment and a title of the second content segment are provided as input to a machine-learning model trained to predict a title for the first content segment that is consistent with the title of the second content segment. One or more outputs of the machine-learning model are obtained which indicate the title for the first content segment. An indication of each content segment and a respective title of each content segment are provided for presentation to at least one user of the one or more users.

### TECHNICAL FIELD

Aspects and implementations of the present disclosure relate to generating titles for content segments of media items at a platform using machine-learning.

### BACKGROUND

A platform (e.g., a content platform) can transmit (e.g., stream) media items to client devices connected to the platform via a network. A media item can include a video item and/or an audio item, in some instances. Users can consume the transmitted media items via a graphical user interface (GUI) provided by the platform. In some instances, one or more content segments of a media item may be more interesting to a user than other content segments. The user may wish to easily access the interesting content segment(s) of the media item without consuming the entire media item via the GUI.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for time marking of media items at a platform using machine-learning. In an implementation, a method includes identifying a media item to be provided to one or more users of a platform. The media item has a plurality of content segments comprising a first content segment and a second content segment preceding the first content segment in the media item. The method further includes providing the first content segment and a title of the second content segment as input to a machine-learning model. The machine-learning model is trained to predict a title for the first content segment that is consistent with the title of the second content segment. The method further includes obtaining one or more outputs of the machine-learning model, wherein the one or more obtained outputs indicate the title for the first content segment. The method further includes providing an indication of each content segment and a respective title of each content segment for presentation to at least one user of the one or more users.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram illustrating an example platform, an example title-generating engine, and an example title-scoring engine, in accordance with implementations of the present disclosure.

FIG. 3 illustrates an example of titled chapters for content segments of a media item, in accordance with implementations of the present disclosure.

FIG. 4 depicts a flow diagram of an example method for training a title-generating machine-learning model to predict one or more content segment titles of a given media item, in accordance with implementations of the present disclosure.

FIG. 5 depicts a flow diagram of an example method for training a title-scoring machine-learning model to predict a quality metric of a predicted content segment title of a given media item, in accordance with implementations of the present disclosure.

FIG. 6 depicts a flow diagram of an example method for automatically generating titles for content segments of media items at a platform using machine-learning, in accordance with implementations of the present disclosure

FIG. 7 is a block diagram illustrating an exemplary computer system, in accordance with implementations of the present disclosure.

### DETAILED DESCRIPTION

Aspects of the present disclosure relate to generating titles for content segments of media items at a platform using machine-learning. A platform (e.g., a content platform, etc.) can enable a user to access a media item (e.g., a video item, an audio item, etc.) provided by another user of the platform. For example, a first user of a content platform can provide (e.g., upload) a media item to a content platform via a graphical user interface (GUI) associated with the content platform to a client device of the first user. A second user of the content platform can access the media item provided by the first user via the content platform GUI at a client device associated with the second user. In some instances, a media item can include one or more content segments. In a first example, if the media item includes video content relating to an academic lecture, a first content segment of the media item can depict a discussion of a first topic of the lecture and a second content segment of the media item can depict a discussion of a second topic of the lecture. In a second example, if the media item includes video content and/or audio content relating to a music concert, a first content segment can depict a performance of a first song at the music concert and a second content segment can depict a performance of a second song at the music concert.

In conventional systems, a creator of a media item can provide to the platform an indication of respective content segments of a media item that the creator wishes to present as chapters of the media item to the users of the platform. A chapter can refer to a content item between two time periods of the timeline. In accordance with the first example, a creator of the media item relating to the academic lecture can provide to the content platform an indication of a first time period of a timeline of the media item that corresponds to the first content segment depicting the discussion of the first topic of the lecture and another indication of a second time period of the media item timeline that corresponds to the second content segment depicting the discussion of the second topic of the lecture. When a user accesses the media item, the content platform GUI can include a GUI element (e.g., a segment start indicator) indicating the first time period corresponding to the first content segment highlighted by the media item creator and/or the second time period corresponding to the second content segment highlighted by the media item creator. Each segment start indicator can indicate the beginning of a chapter of the media item. The user can cause the first content segment (e.g., a first chapter) and/or the second content segment (e.g., a second chapter) to be displayed via the content platform GUI by engaging with (e.g., clicking, selecting, tapping, etc.) the GUI element. Accordingly, the user can access the first content segment, the second content segment, or other content segments (e.g., the segments that are highlighted by the media item creator) without consuming the entire media item. In accordance with the second example, the creator of the media item relating to the music concert can provide an indication of a first time period of the media item timeline at which the performance of the first song begins and/or another indication of a second time period of the media item timeline at which the performance of the second song begins. The content platform GUI can include a GUI element indicating the start of the first chapter and/or the second chapter, as described above.

For each content segment, the creator (or other users of the platform) can affix a descriptive heading or caption identifying the subject matter of the content segment, commonly referred to as a chapter title. The chapter title can allow the user to quickly navigate through content segments of the media item to locate subject matter of interest. In accordance with the second example, the creator of the media item relating to the music concert can provide the name of the first song as the chapter title of the first time period and the name of the second song as the chapter title of the second time period. This allows users to quickly select, for playback, a song or performance of interest from the media item relating to the music concert.

It can take a significant amount of time and computing resources for a media item creator to determine chapter titles for each content segment and appropriately label the respective content segments with the chapter titles. For example, an academic lecture depicted by the media item can be long (e.g., can last one hour, two hours or more, etc.) and can cover a large number of topics. It can take a significant amount of time for the media item creator to consume the media item, accurately determine a respective time period of the media item timeline that corresponds to a respective topic, and provide a chapter title for each content segment at the determined respective time period to the platform. As the media item creator may need to consume one or more portions of the media item several times to determine and provide accurate chapter titles, computing resources of the client device that enable the media item creator to consume the media item can be unavailable for other processes, which can decrease overall efficiency and increase overall latency of the client device.

Aspects of the present disclosure address the above and other deficiencies by providing techniques for generating chapter titles for content segments of media items at a platform using machine-learning. A media item creator can provide a media item to a platform for access by users of the platform. The media item can correspond to a video item and/or an audio item. In some embodiments, before (or after) the media item is made accessible to the platform users, time marks indicative of different content segments of the given media item can be generated (e.g., based on input from a content creator or automatically). The time marks can depict distinct sections (e.g., chapters) of the media item to platform users. The platform can associate each identified content segment of the media item with a segment start indicator for a timeline of the media item. The platform can provide the media item to one or more client devices associated with users of the platform (e.g., in response to one or more requests) for presentation of the media item to the users. The platform can also provide, with the media item, an indication of each segment start indicator associated with the media item. A user interface (UI) associated with the platform can include one or more UI elements corresponding to the segment start indicators at a portion of a timeline for the media item that includes the content segment associated with each segment start indicator. Responsive to detecting that the user has engaged with the UI element, the platform can initiate playback of the content segment via the platform UI.

An indication of the media item can then be provided as input to a machine-learning model that is trained to predict, for a given media item, chapter titles for the different content segments of the given media item. The machine-learning model can be trained using historical data associated with other media items that have been previously provided (e.g., by media item creators) to the platform. For example, the machine-learning model can be trained using historical data that includes an indication of a respective media item that was previously provided to the platform and indications of different chapter titles for different content segments of the respective media item. Further details regarding training the machine-learning model are provided herein. Responsive to providing an indication of the media item as input to the machine-learning model, the platform can obtain one or more outputs of the model. The one or more outputs can include chapter titles for each identified content segment of the media item. Accordingly, the platform can automatically assign chapter titles to specific content segments of the media item without a user needing to consume the entire media item to determine the chapter titles. Furthermore, as will be discussed in more detail below, in some implementations, the chapter titles generated by the platform are consistent (e.g., use consistent format, consistent terminology, consistent length, etc.) throughout the media item, and provide objective accurate descriptions of the content segments (e.g., contrary to subjectively provided manual titles that could be considered descriptive by only those users who created those titles, and would therefore result in unnecessary consumption by other users of content segments in which they are not interested).

Aspects of the present disclosure cover techniques to enable users of a platform accessing a media item to view chapter titles for particular or distinctive content segments of the media item. As soon as, or soon after, a media item is provided to a platform, the platform can assign chapter titles to different content segments of the media item based on outputs of a trained machine-learning model. Accordingly, chapter titles for the media item can be automatically (without user input identifying chapter titles in any way) determined before the media item is accessible by the platform users, and therefore each user accessing the media item is able to identify the particular content segments of the media item without consuming the entire media item. By automatically determining one or more chapter titles for distinct content segments of a media item based on output(s) of a machine-learning model, it is not necessary for a creator associated with the media item to consume the media item (sometimes multiple times) to label content segments for users and to accurately provide descriptions for such content segments to be associated with one or more content segments. Accordingly, computing resources at a client device associated with the media item creator and/or the platform are reduced and are available for other processes, which increases an overall efficiency and decreases an overall latency for the system.

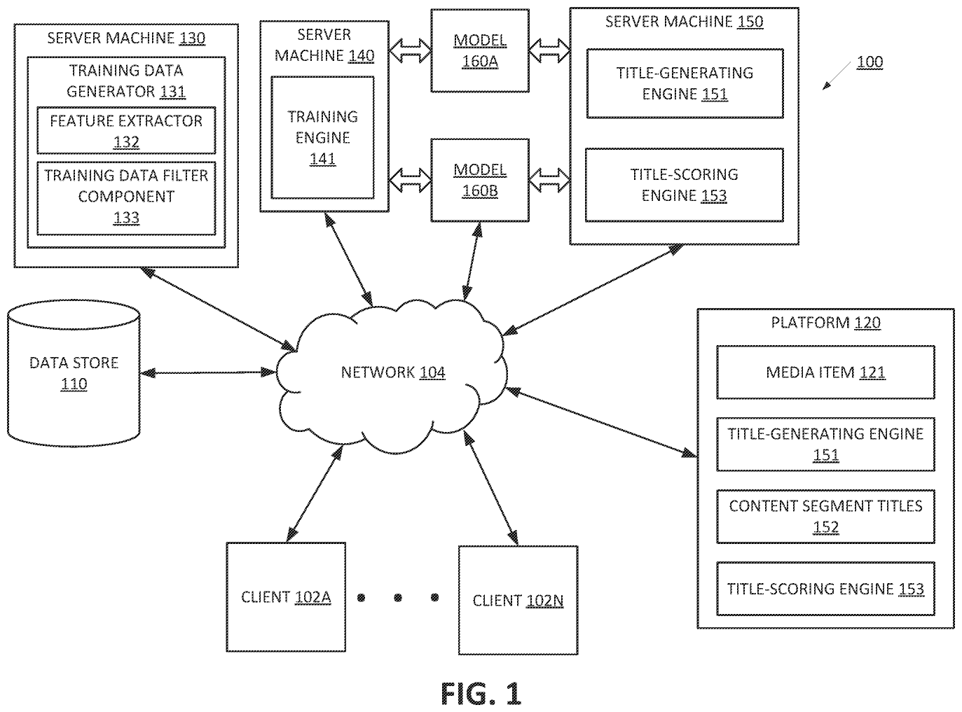

FIG. 1 illustrates an example system architecture 100, in accordance with implementations of the present disclosure. The system architecture 100 (also referred to as “system” herein) includes client devices 102A-N, a data store 110, a platform 120, and/or a server machine 150 each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third party platform can provide other services associated media items 121. For example, a third party platform can include an advertisement platform that can provide video and/or audio advertisements. In another example, a third party platform can be a video streaming service provider that produces a media streaming service via a communication application for users to play videos, TV shows, video clips, audio, audio clips, and movies, on client devices 102 via the third party platform.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

In some embodiments, media item 121 can include one or more content segments. Each content segment can include a corresponding segment start indicator. A segment start indicator refers to an indication of the particular content segment that is provided via the UI of the content viewer provided by platform 120 (referred to simply as platform UI herein). Each segment start indicator can correspond to a time mark. A time mark refers to an indication of a time period of a timeline of media item 121 that begins a particular content segment. Accordingly, each segment start indicator can indicate the beginning of a chapter of the media item. A chapter can refer to the content of a content item between two time marks. Each chapter can be a distinct portion of the media item that can include identifiable or distinguishing content in comparison with other portions of the media item.

As illustrated in FIG. 1, platform 120 can include a title-generating engine 151. Title-generating engine 151 can be configured to determine a title (e.g., name) for each content segment (e.g., for each chapter) of the media item 121. In some embodiments, title-generating engine 151 can determine one or more titles associated with each content segment of a media item 121 using one or more title-generating machine-learning models 160A. For example, platform 120 can receive (e.g., from a client device 102, etc.) a media item 121 that is to be accessible by users of platform 120. In response to receiving the media item 121, title-generating engine 151 can provide an indication of the media item 121 as input to a trained title-generating machine-learning model 160A. Title-generating machine-learning model 160A can be trained to predict, for a given media item, one or more titles for one or more content segments of the given media item, in accordance with embodiments described herein.

Platform 120 can further include a title-scoring engine 153. Title-scoring engine can be configured to determine the quality of each content segment title predicted by the title-generating engine 151. In particular, title-scoring engine 153 can be configured to generate a metric indicative of the quality for a given content segment title. By way of illustrative example, the metric can be a value (referred to a title quality value) between 0 and 1. In some embodiments, title-scoring engine 153 can compare the generated value to a predetermined threshold criterion to determine whether to assign a predicted title to the corresponding content segment. In some embodiments, title-scoring engine 153 can determine a probability of title-scoring engine 153 generating a value of 1, and compare the value reflecting said probability to a predetermined threshold criterion to determine whether to assign a predicted title to the corresponding content segment. The predetermined criterion can include, for example, a user defined threshold value. Responsive to the metric (e.g., title quality value) satisfying the threshold criterion (e.g., a threshold value), the title-scoring engine 153 can assign the predicted title to the corresponding content segment. Responsive to the metric failing to satisfy the threshold criterion, the title-scoring engine 153 can discard (e.g., not assigned) the title predicted for corresponding content segment. In some embodiments, title-generating engine 151 can determine a title quality value for each predicted title associated with each content segment of a media item 121 using one or more title-scoring machine-learning models 160B. For example, platform 120 can receive (e.g., from a client device 102, etc.) a predicted title generated by title-generating engine 151. In response to receiving the predicted title, title-generating engine 151 can provide an indication of the predicted title as input to a trained title-scoring machine-learning model 160. Title-scoring machine-learning model 160B can be trained to predict, for a given predicted title, a metric indicative of the quality of the title, in accordance with embodiments described herein.

Training data generator 131 (e.g., residing at server machine 130) can generate training data to be used to train models 160A, B. Regarding title-generating machine-learning model 160A, in some embodiments, training data generator 131 can generate the training data based on one or more training media items (e.g., stored at data store 110 or another data store connected to system 100 via network 104). In an illustrative example, data store 110 can be configured to store a set of training media items and metadata associated with each training media item of the set of training media items. In some embodiments, the metadata associated with a respective training media item can indicate one or more characteristics associated with the media item, such as the media item title, the chapter index, the amount of chapters in the media item 121, etc. The media item title refers to the name of the particular media item 121, such as the name of a video (e.g., a video title). The chapter index can include a start time of each chapter of the media item 121. In particular, the chapter index can include one or more time marks each indicative of a time period of a timeline of media item 121 that begins each content segment of the media item 121. The amount of chapters can be indicative of the total amount of content segments that are included in the media item 121, which can be indicated by the total amount of segment start indicators associated with the media item 121. In some embodiments, the metadata associated with a respective training media item can also indicate one or more characteristics associated with one or more content segments of the media item, such as user-defined titles of each content segment. These user-defined content segment titles refer to the name of each content segment of a particular media item 121 (e.g., a chapter title) and can be generated based on user-input.

To generate the training data, training data generator 131 can first use one or more feature extractors 132 to extract, from each training media item, data (e.g., audio transcription data) relating to one or more audio related features. Feature extractor 132 can be part of training data generator 131 (as shown), or independent components hosted by server machine 130 (not shown) or on any other external device or server machine. Audio transcription data can include a transcription of the audio data of each content segment. In some embodiments, feature extractor 132 can generate the audio transcription data using a text extractor system (e.g., software, an algorithm, etc.). For example, feature extractor 132 can convert audio data corresponding to a media item (or corresponding to one or more content segments of the media item) into text data. Examples of the text feature extractor system can include a text-embedding model (e.g., the universal sentence embedding model), a speech recognition model, a speech-to-text model, etc.

In some embodiments, the audio transcription data can be generated by user input. For example, a user (e.g., a creator) can generate a transcript of the audio corresponding to one or more content segments of a media item. The transcript can be included, for example, as metadata related to the media item. In some embodiments, the audio transcription data can be generated using an optical character recognition (OCR) system. An OCR system can include a software tool that converts visual data (e.g., images, frames, etc.) into editable and searchable text. In one example, an OCR system can generate text data from closed captions or subtitles associated with a media item 121 (e.g., if such closed captions or subtitles associated with the media item 121 are not otherwise available). To generate the training data, training data generator 131 can extract, from each training media item, audio transcription data and characteristic data relating to one or more content segments of the media item.

In some embodiments, training data generator 131 can generate training data by concatenating (linking together) one or more features associated with the media item into a text string. For example, training data generator 131 can generate, for each content segment, a text string that includes one or more of the media item title, a title of one or more content segments chronologically preceding the said content segment (e.g., for the third content segment of a media item, include the titles of the first and second content segments of the media item), a chapter index, the amount of chapters in the media item, and/or the audio transcription data for said content segment.

In some embodiments, training data generator 131 can include training data filter component 133. Training data filter component 133 can be configured to remove substandard training data. In particular, training data filter component 133 can include one or more filters that can be applied to each set of training data. Responsive to the training data set (or the respective content segment or media item) failing to satisfy a condition of a respective filter, training data filter component 133 can remove the training data set from the training data generator 131 or data store 110 to prevent the failed training data set from being used to train machine learning model 160A, B. The training data filters can include a word count filter, a language filter, a character type filter, a character length filter, a number filter, a token-based filter, etc. The word count filter can remove a training data related to a content segment that include audio transcription data having a word count below a predetermined threshold. For example, responsive to the audio transcription data of a content segment containing less than twenty-five words, the word count filter can remove the training data associated with said content segment. The language filter can remove a training data related to a content segment that that include audio in not a particular language. For example, responsive to the audio transcription data including text in a language other than English, the language filter can remove the training data associated with said content segment. The character type filter can remove a training data related to a content segment that includes specific characters in the title or the audio transcription data. In one example, responsive to the audio transcription data including one or more non-English ASCII (American Standard Code for Information Interchange) characters, the character type filter can remove the training data associated with said content segment. In another example, responsive to the title including one or more non-alphanumeric characters (e.g., “:” or “;”), the character type filter can remove the training data associated with said content segment. The character length filter can remove a training data related to a content segment that includes a title shorter or longer than a predetermined threshold. For example, responsive to the user-defined title including less than four characters, the character length filter can remove the training data associated with said content segment. The number filter can remove a training data related to a content segment that includes numbers or dates at the start of a title. The token filter can remove a training data related to a content segment that include user-defined metrics. For example, media items can include content segments labeled “Number 1, Number 2, . . . , Number N” or “Book 1, Book 2, . . . , Book N.” Accordingly, the token filter can remove the training data associated with said content segments that include titles matching a user-defined token (e.g., removes content segment or media items with “Book X” or “Number X” in the title, where X can be any integer). Each training data filter can be programmatically defined, or specified or modified by user-input.

Regarding title-scoring machine-learning model 160B, in some embodiments, training data generator 131 can generate the training data based on one or more training media items. In an illustrative example, data store 110 can be configured to store a set of training media items and metadata associated with each training media item of the set of training media items. In some embodiments, the metadata associated with a respective training media item can indicate one or more characteristics associated with the media item, such as the media item title, the chapter index, the amount of chapters in the media item 121, etc. In some embodiments, the metadata associated with a respective training media item can indicate one or more characteristics associated with one or more content segments of the media item, such as content segment titles. In some embodiments, the training data can further include one or more titles predicted by title-generating engine 151. For example, for each content segment of a training media item, the training data can include a title predicted by the title-generating engine 151 for said content segment.

In some embodiments, machine-learning model 160A can be a supervised machine-learning model. In such embodiments, training data used to train model 160A can include a set of training inputs and a set of target outputs for the training inputs. The set of training inputs can include an indication of each content segment of each media item of the set of training media items. For example, the set of training inputs can include a text string including the media item title, the titles of one or more content segment chronologically preceding each current content segment, the chapter index for the media item, the amount of chapters in the media item, and/or the audio transcription data for the current content segment. The set of target outputs can include an indication of a content segment title of the respective training media item.

In some embodiments, machine-learning model 160B can be a supervised machine-learning model. In such embodiments, training data used to train model 160B can include a set of training inputs and a set of target outputs for the training inputs. The set of training inputs can include an indication of each content segment of each media item of the set of training media items. For example, the set of training inputs can include audio transcription data for the current content segment and the title predicted by title-generating engine 151. In other embodiments, the set of training inputs can include any of the media item title, the titles of one or more content segment chronologically preceding each current content segment, the chapter index for the media item, the amount of chapters in the media item, the title predicted by title-generating engine 151, and/or the audio transcription data for the current content segment. The set of target outputs can include an indication of a title quality value (e.g., a value between 0 and 1) of the respective content segment. In some embodiments, the value of 1 can correspond to a match between the title predicted by title-generating engine 151 and a user generated title, and the value of 0 can correspond to a mismatch between the title predicted by title-generating engine 151 and the user generated title.

Server machine 140 may include a training engine 141. Training engine 141 can train a machine-learning model 160A, B using the training data from training data generator 131. In some embodiments, the machine-learning model 160A, B can refer to the model artifact that is created by the training engine 141 using the training data that includes training inputs and corresponding target outputs (correct answers for respective training inputs). The training engine 141 can find patterns in the training data that map the training input to the target output (the answer to be predicted), and provide the machine-learning model 160A, B that captures these patterns. The machine-learning model 160A, B can be composed of, e.g., a single level of linear or non-linear operations (e.g., a support vector machine (SVM) or may be a deep network, i.e., a machine-learning model that is composed of multiple levels of non-linear operations). An example of a deep network is a neural network with one or more hidden layers, and such a machine-learning model can be trained by, for example, adjusting weights of a neural network in accordance with a backpropagation learning algorithm or the like. In other or similar embodiments, the machine-learning model 160A, B can refer to the model artifact that is created by training engine 141 using training data that includes training inputs. Training engine 141 can find patterns in the training data, identify clusters of data that correspond to the identified patterns, and provide the machine-learning model 160A, B that captures these patterns. Machine-learning model 160A, B can use one or more of transformer model, support vector machine (SVM), Radial Basis Function (RBF), clustering, supervised machine-learning, semi-supervised machine-learning, unsupervised machine-learning, k-nearest neighbor algorithm (k-NN), linear regression, random forest, neural network (e.g., artificial neural network), etc.

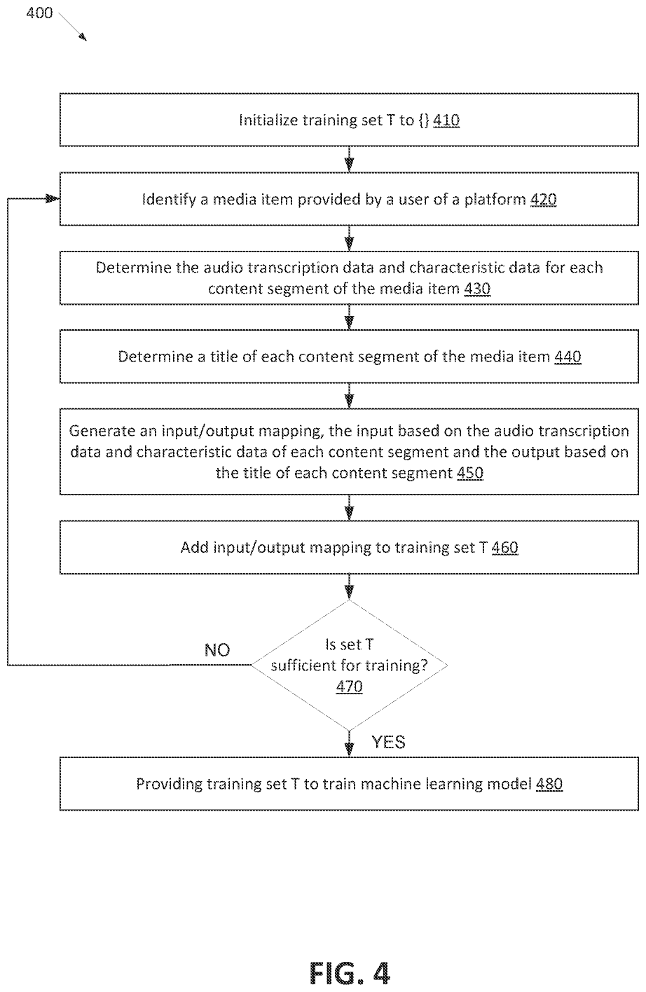

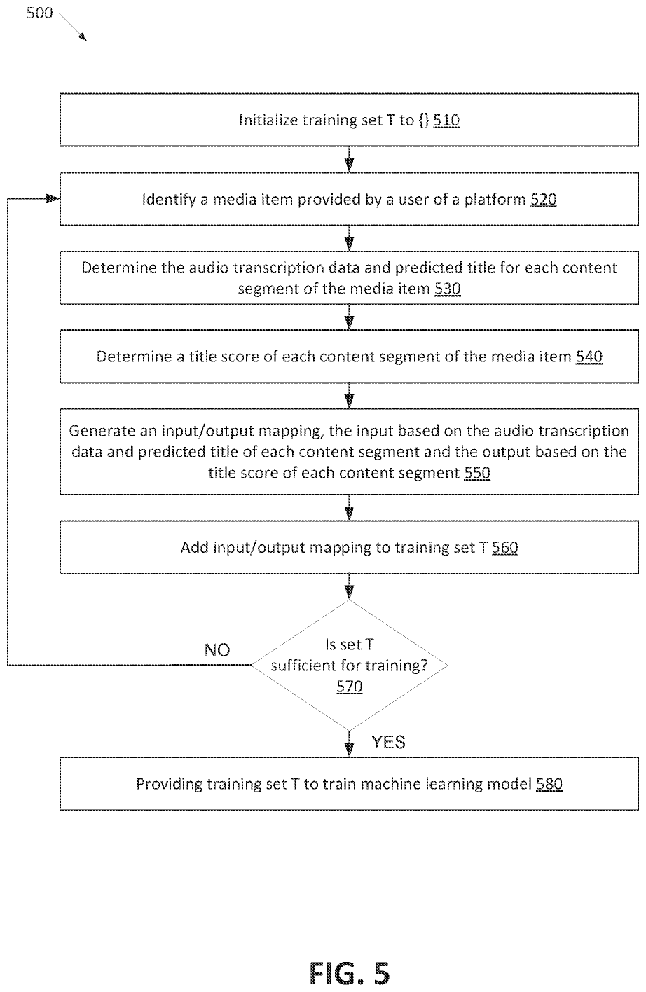

A transformer model is a neural network or deep learning model that learns context and meanings by tracking relationships in sequential data like the words in this sentence. Transformer models can apply an evolving set of mathematical techniques, called attention or self-attention, to detect subtle ways that data elements in a series influence and depend on each other. Transformer models can use encoder modules, decoder modules, or a combination of both. The encoder module can include multiple encoding layers that process the input iteratively one layer after another. The decoder module can include multiple decoding layers that process the encoder's output iteratively one layer after another. Each encoder layer can generate encodings that contain information about which parts of the inputs are relevant to each other. The encoder module then passes its encodings to the next encoder layer as inputs. Each decoder layer does the opposite, taking all the encodings and using their incorporated contextual information to generate an output sequence. To achieve this, each encoder and decoder layer can use an attention mechanism. An attention mechanism can use a technique that mimics cognitive attention causing enhancements to some parts of the input data while diminishing other parts. Further details regarding generating training data and training title-generating machine-learning model 160A are provided with respect to FIG. 4. Further details regarding generating training data and training title-scoring machine-learning model 160B are provided with respect to FIG. 5.

Server 150 includes a title-generating engine 151 and title-scoring engine 153. As indicated above, title-generating engine 151 can determine titles associated with one or more content segments of a media item 121 using one or more machine-learning models 160A trained as described herein. In some embodiments, title-generating engine 151 can provide an indication of the media item 121 as input to machine-learning model 160 to obtain one or more outputs. The machine-learning model 160 can provide one or more outputs that include titles identifying each content segment of the media item 121. For example, each title can correspond to each particular chapter of the media item. Title-scoring engine 153 can determine the quality of each title predicted by the title-generating engine 151. Responsive to title-scoring engine 153 assigning a predicted title to a corresponding content segment, title-generating engine 151 can determine a time period of the timeline of media item 121 that includes the chapter and can assign the title with the determined time period. Title-generating engine 151 can store an indication of the content segment title 152 for each content segment at data store 110 (e.g., with metadata for media item 121, etc.). Further details regarding associating content segments with content segment titles 152 are provided herein.

In some embodiments, a client device 102 can transmit a request to access media item 121, as described above. In response to receiving a request to access media item 121, platform 120 can provide the media item 121 for presentation via the platform UI at client device 102. In some embodiments, platform 120 can also transmit an indication of one or more content segment title 152 associated with media item 121. The platform UI can include one or more UI elements that indicate a time period of the timeline of the media item 121 that correspond to the one or more content segment titles 152. In some embodiments, a user of client device 102 can engage with (e.g., click, tap, select, etc.) the one or more UI elements. In response to detecting a user engagement with the one or more UI elements, client device 102 can initiate playback of a respective content segment that corresponds to the content segment title(s) 152 associated with the UI elements. Accordingly, the user can access the interesting content segments of the media item 121 based on auto-generated segment titles 152 without consuming each content segment of the media item 121. Further details regarding the platform UI initiating playback of interesting content segments are provided herein.

It should be noted that although FIG. 1 illustrates title-generating engine 151 as part of platform 120, in additional or alternative embodiments, title-generating engine 151 can reside on one or more server machines that are remote from platform 120 (e.g., server machine 150). In some embodiments, media item management component 122 can transmit data associated with one or more edits to title-generating engine 151 (e.g., via network 108, via a bus, etc.) residing on server machine 150.

It should be noted that in some other implementations, the functions of server machines 130, 140, 150 and/or platform 120 can be provided by a fewer number of machines. For example, in some implementations components and/or modules of any of server machines 130, 140, 150 may be integrated into a single machine, while in other implementations components and/or modules of any of server machines 130, 140, 150 may be integrated into multiple machines. In addition, in some implementations components and/or modules of any of server machines 130, 140, 150 may be integrated into platform 120.

In general, functions described in implementations as being performed by platform 120 and/or any of server machines 130, 140, 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that provide document creation, editing, and/or viewing tools to users. Further, implementations of the disclosure are not limited to text objects or drawing objects and can be applied to other types of objects.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

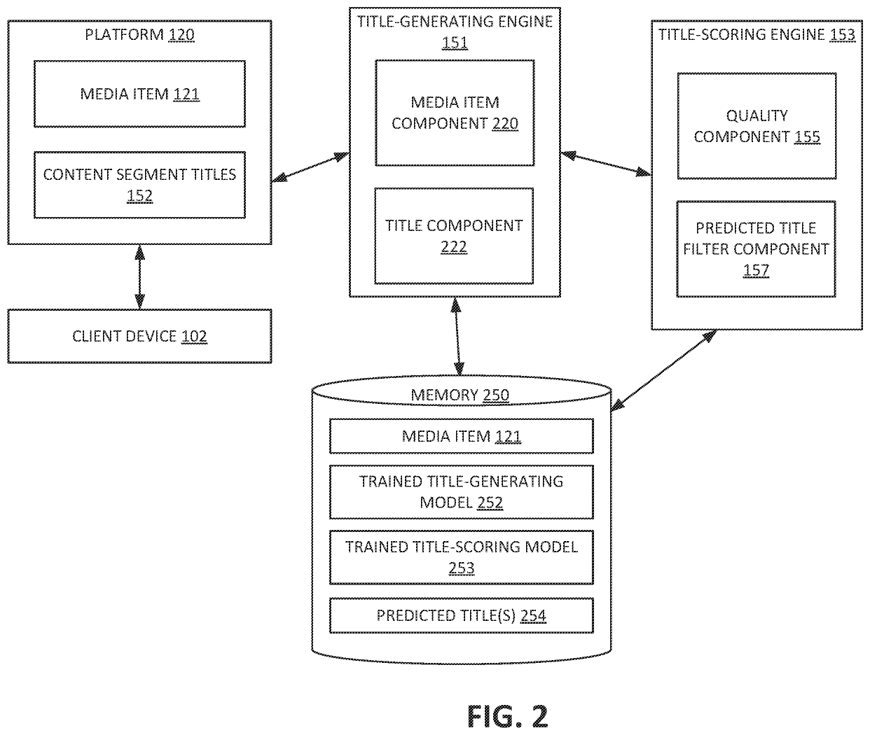

FIG. 2 is a block diagram illustrating an example platform 120, an example title-generating engine 151, and an example title-scoring engine 153, in accordance with implementations of the present disclosure. In some embodiments, platform 120, title-generating engine 151, and/or title-scoring engine 153 can be connected to memory 250. One or more portions of memory 250 can correspond to data store 110 and/or another memory of system 100, in some embodiments. In additional or alternative embodiments, one or more portions of memory 250 can correspond to a memory of client device 102.

As described with respect to FIG. 1, platform 120 can provide users with access to media item(s) 121 hosted by platform 120. In some embodiments, media item (s) 121 can be provided to platform 120 by other users of platform 120. In such embodiments, platform 120 can be a content sharing platform. As described above, a user can access a media item 121 via a UI of a content viewer of a client device 102 associated with the user. In some embodiments, the content viewer can be provided by platform 120. In an illustrative example, client device 102 can transmit a request to access a particular media item 121 hosted by platform 120 (e.g., in response to a user selection, etc.). Platform 120 can identify the particular media item 121 (e.g., from one or more media files residing at data store 110) and can provide access to the particular media item 121 via the content viewer, as described above.

In some embodiments, title-generating engine 151 can include a media item component 220 and a title component 222. Media item component 220 can be configured to identify a media item 121 to be provided to one or more users of platform 120. As indicated above, a creator of media item 121 can provide media item 121 for access by users of platform 120. In response to detecting that the creator has provided (e.g., uploaded) media item 121 to platform 120, media item component 220 can identify the media item 121. In some embodiments, media item component 220 can identify the media item 121 before platform 120 provides media item 121 for access to the users. In other or similar embodiments, platform 120 can receive a request from a client device 102 associated with a user to access media item 121 (e.g., after media item 121 is provided by the creator). In such embodiments, media item component 220 can identify the media item 121 in response to receiving the request.

Title component 222 can determine a predicted title 254 for one or more content segments of media item 121. In response to media item component 220 identifying media item 121, title component 222 can provide an indication of media item 121 as input to trained title-generating model 252. Trained title-generating model 252 can correspond to one or more of model(s) 160A, described with respect to FIG. 1. In some embodiments, trained title-generating model 252 can be trained to predict, for a given media item, a title for each of one or more content segments of the given media item. Trained title-generating model 252 can be trained in accordance with embodiments described above and with respect to FIG. 4, in some embodiments. The one or more predicted titles can be presented as chapters titles to all or most users (e.g., a general population of users) of platform 120, in some embodiments.

In response to providing an indication of media item 121 (and/or one or more characteristics of the user and/or client device 102) as input to trained title-generating model 252, title component 222 can obtain one or more outputs of model 252. As indicated above, the one or more outputs can include predicted titles 254 identifying a description of the content of each content segment of media item 121. For each predicted title 254, title component 222 can then send the predicted title 254 to title-scoring engine 153 to determine a quality of the predicted title. The quality of a predicted title can be indicative of whether the predicted title is assigned to the corresponding content segment.

In some embodiments, title-scoring engine 153 can include a quality component 155 and a predicted title filter component 157. Quality component 155 can determine whether to assign a predicted title to a corresponding content segment. In response to title-generating engine 151 identifying a predicted title, quality component 155 can provide an indication of the predicted title and the audio transcription data of the corresponding content segment as input to trained title-scoring model 253. Trained title-scoring model 253 can correspond to one or more of model(s) 160B, described with respect to FIG. 1. In some embodiments, trained title-scoring model 253 can be trained to predict, for a segment title, a title quality metric (e.g., a title quality value). Trained title-scoring model 253 can be trained in accordance with embodiments described above and with respect to FIG. 5, in some embodiments. Title-scoring engine 153 can then assign the predicted title to the corresponding content segment in response to the predicted title quality metric satisfying a threshold criterion (e.g., a threshold value). Title component 222 can then store an indication of the assigned title(s) as title(s) 254 at memory 250.

Predicted title filter component 157 can be configured to remove substandard predicted titles. In particular, predicted title filter component 157 can include one or more filters that can be applied to each predicted title. Responsive to the predicted title failing to satisfy a condition of a respective filter, predicted title filter component 157 can remove the predicted title to prevent the predicted title from being assigned to a content segment. In some embodiments, the predicted title filters can be similar or the same to the training data filters, and include a word count filter, a language filter, a character type filter, a character length filter, a number filter, a token-based filter, etc. In some embodiments, the predicted title filters can include a duplication filter, an intro/outro filter, minimum chapters filter, and/or a prediction quality filter.

The duplication filter can perform a corrective action in response to detecting that a predicted title is similar or the same as another predicted title associated with a content segment of the same media item. In some embodiments, responsive to detecting consecutive duplicate predicted titles (e.g., two adjacent content segments have the same or similar predicted titles), the duplication filter can merge the two consecutive content segments with the same predicted title. In some embodiments, responsive to detecting a non-consecutive duplicate predicted title (e.g., two non-adjacent content segments have the same or similar predicted titles), the duplication filter can select a next best predicted title for one of the content segments. Responsive to the title-generating engine 151 failing to generate a next best predicted title, or all of the predicted titles being duplicates of other predicted titles for a media item, the duplication filter can remove the chapter from the media item (e.g., combine said chapter with an adjacent chapter).

For any content segment that is not the first content segment or the last content segment of media item, the intro/outro filter can remove a predicted title associated with terminology generally used by a first chapter or a last chapter (e.g., introduction, intro, outro, conclusion, etc.). Accordingly, the title-scoring engine 153 can combine said content segment with an adjacent content segment, or select a next best predicted title.

The minimum chapters filter can remove predicted titles from media items including fewer chapters than a predetermined threshold. For example responsive to a media item including fewer than three chapters, minimum chapters filter can remove the predicted titles from said media item. The prediction quality filter can remove predicted titles from media items from which a threshold number of predicted titles have been removed or filtered. For example, responsive to one or more filters removing predicted titles from more than twenty percent of content segments of a media item, the prediction quality can remove the predicted titles from the remaining content segments of the media item.

Platform 120 can provide access to a media item 121 to a client device 102 associated with a user of platform 120, as described above. In some embodiments, platform 120 can also provide an indication of content segment titles 152 associated with the media item. Client device 102 can present the media item 121 to the user via a UI of a content viewer of client device 102, as described above.

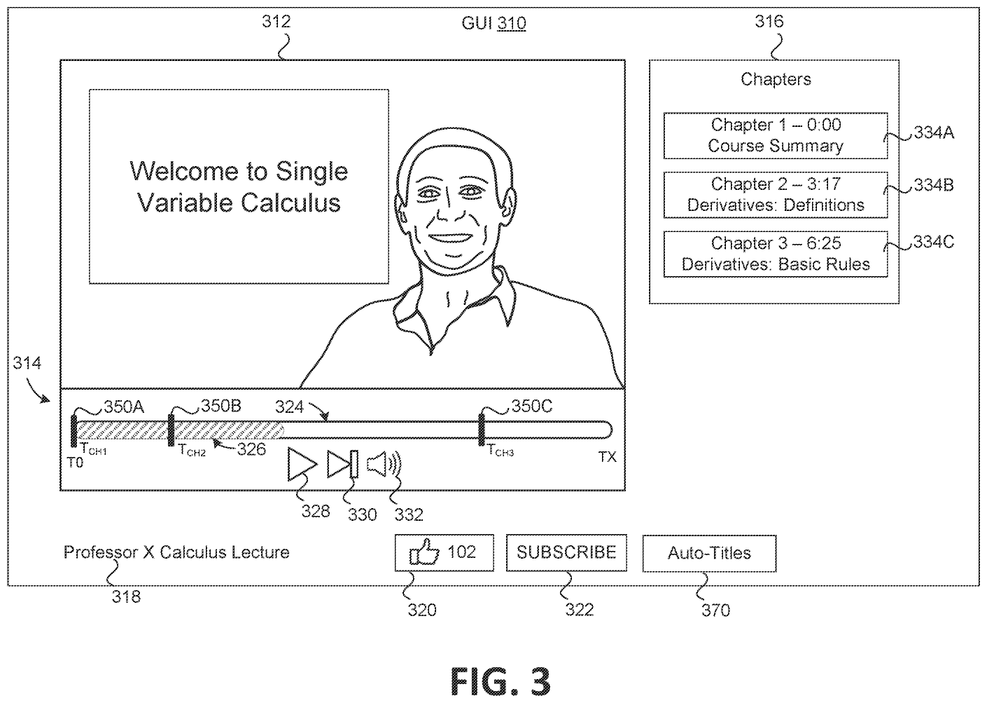

FIG. 3 illustrates an example of a UI 310 of a content viewer provided by platform 120, in accordance with implementations of the present disclosure. In some embodiments, UI 310 can include one or more of a first section 312, a second section 314, and/or a third section 316. In some embodiments, the first section 312 can be configured to display a media item 121 (e.g., for consumption by one or more users of a client device 102). In an illustrative example, media item 121 can include video content and/or audio content relating to an academic lecture (e.g., a calculus lecture). Platform 120 can provide playback of the media item 121 via the first section 312 of UI 310, in some embodiments.

Second section 314 of UI 310 can include one or more UI elements that enable a user of client device 102 to control playback of the media item 121 via the first section 312 of UI 310 and/or provide an indication of metadata associated with the media item 121. As illustrated in FIG. 3, second section 314 can include one or more UI elements 318 that indicate a title associated with media item 121 (e.g., “Professor X Calculus Lecture”). Second section 314 can additionally or alternatively include one or more elements that enable the user to engage with the media item 121. For example, second section 314 can include one or more UI elements 320 that enable the user to endorse (e.g., “like”) the media item 121 and/or one or more UI elements 322 that enable the user to subscribe to a channel associated with the media item 121. UI elements 320 and/or UI elements 322 can additionally or alternatively include information indicating a number of other users that have endorsed the media item 121 and/or have subscribed to a channel associated with the media item 121.

In some embodiments, second section 314 can include one or more UI elements 324 that indicate a timeline associated with the media item 121. A timeline associated with a media item can correspond to a length of a playback of the media item 121. In an illustrative example, playback of media item 121 can be initiated at time T0 (e.g., seconds, minutes, hours, etc.) and can be completed at time TX (e.g., seconds, minutes, hours, etc.). Accordingly, the length of the playback of media item 121 can have a value of X (e.g., seconds, minutes, hours, etc.). As illustrated in FIG. 3, UI elements 324 indicate that the playback of the video is initiated at an initial time period of the timeline (e.g., at time T0) and playback of the video is completed at a final time period of the timeline (e.g., at time TX).

Second section 314 can also include one or more UI elements 326 that indicate a progress of the playback of media item 121 via the first section 312 of UI 310 in view of the timeline of media item 121. One or more characteristics of UI elements 326 (e.g., size, shape, etc.) can change as playback progresses along the timeline of the media item 121. For example, as playback progresses along the timeline of the media item 121 (e.g., from the initial time period at time T0 to the final time period at time TX), the size of UI element(s) 326 can change to indicate time periods of the timeline that include content segments of which playback has been completed. In an illustrative example, UI element(s) 326 can include a timeline progress bar. A size of the progress bar can grow as playback progresses along the timeline of the media item 121 from the initial time period to the final time period. In some embodiments, a user can select with (e.g., click, tap, etc.) a portion of UI element(s) 324 that corresponds to a particular time period of the timeline of media item 121. In response to detecting the user selection, the content viewer can initiate playback of a content segment of the media item 121 that is associated with the particular time period. Platform 120 can update UI element(s) 326 to have a size that corresponds to the particular time period of the timeline that includes the initiated content segment.

Second section 314 can include additional elements that enable a user of client device 102 to control playback of media item 121 via the first section 312 of UI 310. For example, second section 314 can include one or more UI elements 328 that enable a user to initiate playback and/or stop playback of one or more content segments of media item 121. Second section 314 can additionally or alternatively include one or more UI elements 330 that enable the user to terminate playback of the media item 121 and initiate playback of another media item 121. For example, UI element(s) 330 can enable the user to terminate playback of the media item 121 and initiate playback of another media item 121 that is included in a channel associated with the media item 121 and/or is provided by the same creator as the media item 121. In another example, UI element(s) 330 can enable the user to terminate playback of the media item 121 and initiate playback of another media item 121 that is otherwise related to media item 121 (e.g., media item(s) 334 included in third section 316, described below).

As illustrated in FIG. 3, second section 314 can include one or more UI elements 350 that each indicate segment start time indicator(s) 152, determined for content segments of media item 121, as described above. A user associated with client device 102 can engage with (e.g., click, select, tap, etc.) UI element(s) 350 to initiate playback of the content segment corresponding with the respective content segment title 152. For example, a user can engage with UI element 350B to initiate playback of the content segment included in a time period at time T_{CH2} of the timeline for media item 121. In another example, the user can engage with UI element 350C to initiate playback of the content segment included in a time period at time T_{CH3} of the timeline. Accordingly, users of platform 120 can identify and initiate playback of content segments of a media item 121 that are designated as interesting by other users of platform 120 without consuming all of the content segments of media item 121.

In some embodiments, third section 316 can include an indication of one or more chapter UI elements (illustrated in FIG. 3 as chapter buttons 334A-334C) that are related to the content segments on the timeline included in second section 314. In some embodiments, the chapter buttons 334A-C can be provided for display by platform 120. Each selectable button can indicate chapter number (e.g., chapter 1, chapter 2, chapter 3, etc.) of the media item 121, a chapter title (e.g., Course Summary, Derivatives: Definitions, Derivatives: Basic Rules, etc.) of the corresponding content segment of the media item 121, and a start time of the respective chapter on the timeline UI element 324. For example, chapter button 334A is associated with chapter 1 of the media item 121, and begins at T_{CH1} of the timeline. Chapter button 334B is associated with chapter 2 of the media item 121, and begins at T_{CH2} of the timeline. Chapter button 334C is associated with chapter 3 of the media item 121, and begins at T_{CH3} of the timeline. Each chapter button 334A-C can be selected by user input. In response to a user selection of a chapter button 334A-C indicated in third section 316, platform 120 can update UI 310 to initiate playback of the media item 121 at the corresponding time mark on the timeline. For example, responsive to user input selecting chapter button 334B, the platform 120 can update UI 310 to initiate playback of the media item 121 at the 3:17 time period.

In some embodiments, second section 314 can include one or more UI elements 370 that enable the user to request platform 120 to automatically generate content segment titles for a media item. For example, prior to or after the media item is made available to other users on platform 120, a creator can select the auto-chapters UI element 370, which requests title-generating engine 151 to generate titles for the content segments of a media item. In other embodiments, title-generating engine 151 can automatically generate the titles in response to the creator providing the media item 121 to platform 120.

In some embodiments, UI 310 can include one or more additional UI elements (not shown) that provide information associated with the content segment associated with UI element(s) 310. For example, the one or more additional UI elements can include an indication of a description associated with the content segment or an indication of details associated with the content of the content segment (e.g., a name of characters or actors depicted in the content of the content segment, a location associated with the content of the content segment, etc.). In some embodiments, platform 120 and/or client device 102 can update UI 310 to include the one or more additional UI elements, for example, in response to detecting that a user has engaged with (e.g., tapped, selected, clicked, hovered over, etc.) UI element(s) 310.

FIG. 4 depicts a flow diagram of an example method 400 for training a title-generating machine-learning model to predict one or more content segment titles of a given media item, in accordance with implementations of the present disclosure. Method 400 can be performed by processing logic that can include hardware (circuitry, dedicated logic, etc.), software (e.g., instructions run on a processing device), or a combination thereof. In one implementation, some or all of the operations of method 400 can be performed by one or more components of system 100 of FIG. 1. In some embodiments, some or all of the operations of method 400 can be performed by training data generator 131 and/or training engine 141, as described above.

At block 410, processing logic initiates training set T to { } (e.g., to empty).

At block 420, processing logic identifies a media item provided by a user of a platform. The media item can correspond to media item 121, as described above.

At block 430, processing logic determines the audio transcription data and the characteristic data (e.g., a media item title, the chapter index, the amount of chapters in the media item 121, the content segment title of each content segment chronologically before a current content segment, etc.) of each content segment of the media item. In some embodiments, processing logic can determine the audio transcription data and the characteristic data in accordance with embodiments described with respect to FIG. 1. In some embodiments, the processing logic can concatenate the audio transcription data and the characteristic data into a text string.

At block 440, processing logic determines a title of each content segment of the media item. The title of each content segment can be user defined and stored as metadata associated with the corresponding content segment.

At block 450, processing logic generates an input/output mapping, the input based on the audio transcription data and the characteristic data, and the output based on a respective user defined title of each content segment.

At block 460, processing logic adds the input/output mapping to training set T.

At block 470, processing logic determines whether set T is sufficient for training. In response to processing logic determining that set T is not sufficient for training, method 400 can return to block 420. In response to processing logic determining that set T is sufficient for training, method 400 can proceed to block 480.

At block 480, processing logic provides training set T to train a machine-learning model, such as title-generating machine-learning model 160A and/or 252, as described above (e.g., by deriving correspondences between audio transcription data and characteristic data of content segments of a media item and user defined titles of respective content segments of the media item).

Once the machine-learning model is trained based on training set T, the machine-learning model can predict, based on a given media item, one or more content segments titles of the media item. In some implementations, the machine-learning model is trained to predict titles that are consistent (e.g., using consistent format, length, terminology, etc.) throughout the media item (e.g., by implementing specific rules and/or conditions). This is because the training data may contain only consistent titles allowing the machine-learning model to learn the pattern. For example, if the first two content segments have the titles “apple” and “banana,” respectively, and the predicted titles for the third chapter includes “cherry,” “fruit,” and “fruit number 3,” the trained machine-learning model will be more likely predict “cherry” than other semantically correct titles, because cherry is more consistent with “apple” and “banana”. Further, one or more filters using rules and/or heuristics can remove certain titles predicted by the machine-learning model. For example, one or more filters (e.g., the number filter, the token-based filter, etc.) can remove titles that contain a substring of “number {integer},” which would remove “fruit number 3” in the above example.

FIG. 5 depicts a flow diagram of an example method 500 for training a title-scoring machine-learning model to predict a quality metric of a predicted content segment title of a given media item, in accordance with implementations of the present disclosure. Method 500 can be performed by processing logic that can include hardware (circuitry, dedicated logic, etc.), software (e.g., instructions run on a processing device), or a combination thereof. In one implementation, some or all of the operations of method 500 can be performed by one or more components of system 100 of FIG. 1. In some embodiments, some or all of the operations of method 500 can be performed by training data generator 131 and/or training engine 141, as described above.

At block 510, processing logic initiates training set T to { } (e.g., to empty).

At block 520, processing logic identifies a media item provided by a user of a platform. The media item can correspond to media item 121, as described above.

At block 530, processing logic determines the predicted content segment title and the audio transcription data of each content segment of the media item. In some embodiments, processing logic can determine the audio transcription data in accordance with embodiments described with respect to FIG. 1. In some embodiments, processing logic can determine the predicted content segment title based on the output of title-generating engine 151. In some embodiments, the processing logic can concatenate the audio transcription data and the predicted title of each content segment into a text string.

At block 540, processing logic determines a title score for each content segment of the media idem. The title score can be based on whether the predicted title matches the user-defined title. In response to the predicted title matching the user-defined title, the title score can be set to a value of 1. In response to the predicted title failing to match the user-defined title, the title score can be set to a value of 0.

At block 550, processing logic generates an input/output mapping, the input based on the audio transcription data and the predicted title data, and the output based on title score for each content segment.

At block 560, processing logic adds the input/output mapping to training set T.

At block 570, processing logic determines whether set T is sufficient for training. In response to processing logic determining that set T is not sufficient for training, method 500 can return to block 520. In response to processing logic determining that set T is sufficient for training, method 500 can proceed to block 580.

At block 580, processing logic provides training set T to train a machine-learning model, such as title-generating machine-learning model 160B and/or 253, as described above.

Once processing logic provides training set T to train the machine-learning model, the machine-learning model can predict, based on a predicted title, one or more metrics indicative of a quality of the predicted title.

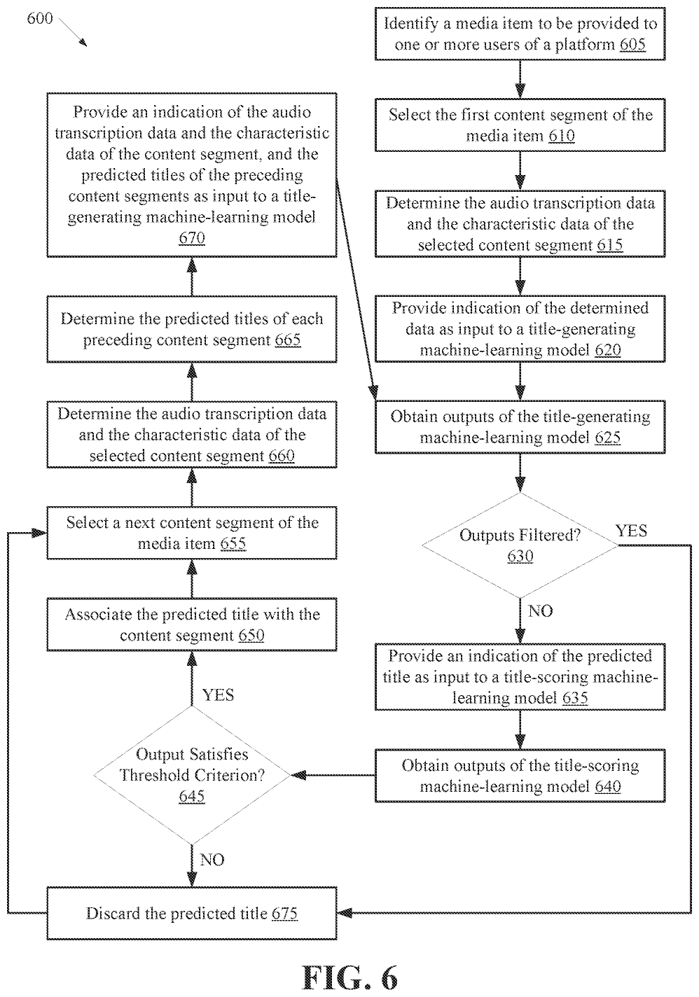

FIG. 6 depicts a flow diagram of an example method 600 for automatically generating titles for content segments of media items at a platform using machine-learning, in accordance with implementations of the present disclosure. Method 600 can be performed by processing logic that can include hardware (circuitry, dedicated logic, etc.), software (e.g., instructions run on a processing device), or a combination thereof. In one implementation, some or all of the operations of method 600 can be performed by one or more components of system 100 of FIG. 1. In some embodiments, some or all of the operations of method 600 can be performed by title-generating engine 151 and/or title-scoring engine 153, as described above.

At block 605, processing logic identifies a media item to be provided to one or more users of a platform. In some embodiments, the media item can be provided by a creator of the media item and can be identified before the media item is accessible to the one or more users of the platform.

At block 610, processing logic selects the first content segment of the media item. For example, the processing logic can select the content segment having a time mark as the initial time period of the media item 121 (e.g., TO). In some embodiments, processing logic can automatically generate time marks for particular content segments (e.g., chapters) of the media item using machine-learning. In particular, before (or after) the media item is made accessible to the platform users, an indication of the media item can be provided as input to a machine-learning model that is trained to predict, for a given media item, time marks indicative of different content segments of the media item. The time marks can depict distinct sections of the media item to platform users. The machine-learning model can be trained using historical data associated with other media items that have been previously provided (e.g., by media item creators) to platform 120. For example, the machine-learning model can be trained using historical data that includes an indication of a respective media item that was previously provided to the platform and indications of different content segments of the respective media item. More specifically, the machine-learning model can be trained using, as input data, one or more instances that includes time slices (e.g., data for each one-second interval of the media item) of video data, audio data, and transcription data. The instances can be obtained using one or more feature extractors. The input data used for training can further include chapter label data indicative of user-defined content segment start periods (e.g., the time period when each content segment begins). The output data used to train the machine-learning model can include duration data related to the duration of each content segment. Responsive to providing an indication of the media item as input to the machine-learning model, the platform can obtain one or more outputs of the model that include time marks (obtained in view of the duration data) indicating each identified content segment of the media item. The platform can associate each identified content segment of the media item with a segment start indicator for a timeline of the media item.

At block 615, processing logic determines the audio transcription data and the characteristic data of the selected content segment. In some embodiments, processing logic can determine the audio transcription data and the characteristic data in accordance with embodiments described with respect to FIG. 1.

At block 620, the processing logic provides an indication of the audio transcription data and the characteristic data of the content segment as input to a title-generating machine-learning model. The title-generating machine-learning model (e.g., model 252) can be trained using historical media items to predict, for a given content segment, one or more titles of the given content segment. In some embodiments, prior to being provided as input, processing logic can convert the audio transcription data and the characteristic data into, for example, a text string.

At block 625, processing logic obtains one or more outputs of the title-generating machine-learning model. The one or more outputs can include one or more predicted titles for the content segment.

At block 630, processing logic determines whether the predicted title is substandard by applying one or more filters to the predicted title. In some embodiments, processing logic can apply the one or more filters in accordance with embodiments described with respect to the title filter component 157 discussed in FIG. 2. Responsive to the predicted title failing to satisfy a condition of a respective filter, processing logic proceeds to block 675 where processing logic discards the predicted title(s). Processing logic then proceeds to block 655 where the processing logic selects a next segment of the media item. Responsive to the predicted title satisfying the conditions of one or more respective filters, processing logic proceeds to block 635.

At block 635, processing logic provides an indication of the predicted title(s) as input to a title-scoring machine-learning model. The title-scoring machine-learning model (e.g., model 253) can be trained using historical media items to predict, for a given predicted title, a title quality value or a probability value that the predicted title quality value will be equal to a predetermined value “e.g., a value of 1.”

At block 640, processing logic obtains one or more outputs of the title-scoring machine-learning model. The one or more outputs can include one or more of a title quality value or a probability value for one or more predicted titles.

At block 645, processing logic determines whether the title quality value or probability value associated with the predicted title(s) are greater than a threshold criterion (e.g., a threshold value). Responsive to the title quality value or probability value being equal to or greater than the threshold criterion, processing logic proceeds to block 650. For example, responsive to the title quality value or the probability value being greater than 0.8, processing logic can proceed to block 650. Responsive to the title quality value or probability value being less than the threshold criterion, processing logic proceeds to block 675, where processing logic discards the predicted title(s). For example, responsive to the title quality value or the probability value being less than 0.8, processing logic proceeds to block 675. Processing logic then proceeds to block 655 where the processing logic selects a next segment of the media item.

At block 650, processing logic associates the predicted title with the content segment. The predicted title (and the segment start indicator for a timeline of the media item) can then be provided for presentation to at least one user of the one or more users.

At block 655, processing logic selects a next content segment of the media item. For example, the processing logic can select the content segment associated with a segment start indicator sequentially after the last processed content segment.

At block 660, processing logic determines the audio transcription data and the characteristic data of the selected content segment. In some embodiments, processing logic can determine the audio transcription data and the characteristic data in accordance with embodiments described with respect to FIG. 1.

At block 665, processing logic determines the predicted titles of each preceding content segment. For example, if the selected content segment is the third content segment of the media item (e.g., chapter three), then the processing logic determines the predicted titles of the first and second content segment. This allows the title-generating machine-learning model to generate subsequent titles for remaining content segments of the media item that are consistent (e.g., have consistent format, length, terminology, etc.) with the previously generated titles. In embodiments where one or more preceding content segment is untitled (e.g., the predicted title was removed by predicted title filter component 157), no title for said segment is provided.

At block 670, the processing logic provides an indication of the audio transcription data and the characteristic data of the content segment, and the predicted titles of the preceding content segments as input to a title-generating machine-learning model. In some embodiments, prior to being provided as input, processing logic can convert the audio transcription data, the characteristic data, and the preceding titles into, for example, a text string. Processing logic then proceeds to block 625, where processing logic obtains one or more outputs of the title-generating machine-learning model. The one or more outputs can include one or more predicted titles for the content segment.

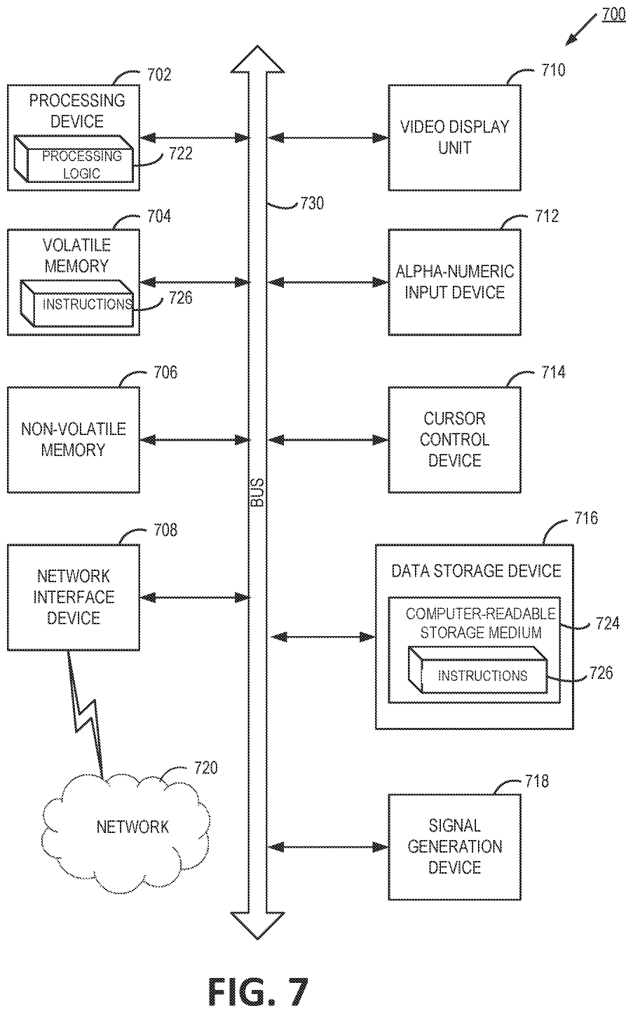

FIG. 7 is a block diagram illustrating an exemplary computer system 1000, in accordance with implementations of the present disclosure. The computer system 700 can correspond to platform 120 and/or client devices 102A-N, described with respect to FIG. 1. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 (e.g., for time marking of media items at a platform using machine-learning) for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 (e.g., for time marking of media items at a platform using machine-learning) embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying a media item to be provided to one or more users of a platform, the media item having a plurality of content segments comprising a first content segment and a second content segment preceding the first content segment in the media item;
providing the first content segment and a title of the second content segment as input to a first machine-learning model trained to predict a title for the first content segment that is consistent with the title of the second content segment;
obtaining one or more outputs of the first machine-learning model, wherein the one or more obtained outputs indicate the title for the first content segment;
providing the one or more obtained outputs of the first machine-learning model as input to a second machine-learning model trained to predict a title quality for a predicted title;
obtaining one or more outputs of the second machine-learning model indicative of the title quality of the title for the first content segment; and
responsive to determining that the one or more outputs of the second machine-learning model satisfies a threshold criterion, providing the media item, an indication of each content segment and a respective title of each content segment for presentation to at least one user of the one or more users.

2. The method of claim 1, further comprising:
associating each content segment with a segment start indicator for a timeline of the media item.

3. The method of claim 1, wherein the input to the machine-learning model comprises a text string generated from at least one of a media item title, a content segment title, a content segment index, a number of content segments of the media item, or audio transcription data.

4. The method of claim 1, further comprising:
applying one or more filters to the one or more obtained outputs of the machine-learning model; and
responsive to the one or more obtained outputs failing to satisfy at least one condition of the one or more filters, discarding the one or more outputs.

5. (canceled)

6. The method of claim 1, further comprising:
detecting that the at least one user of the one or more users has engaged with a user interface (UI) element of a UI provided to a client device associated with the at least one user by the platform, wherein the UI element corresponds to a segment start indicator associated with the first content segment having the provided title; and
initiating playback of the first content segment associated with the segment start indicator and having the provided title via the client device.

7. The method of claim 1, wherein the media item is identified responsive to a request from a client device associated with a creator of the media item to provide user access to the media item via the platform.

8. The method of claim 1, wherein the media item comprises at least one of a video item or an audio item.

9. A system comprising:
a memory device; and
a processing device coupled to the memory device, the processing device to perform operations comprising:
identifying a media item to be provided to one or more users of a platform, the media item having a plurality of content segments comprising a first content segment and a second content segment preceding the first content segment in the media item;
providing the first content segment and a title of the second content segment as input to a first machine-learning model trained to predict a title for the first content segment that is consistent with the title of the second content segment;
obtaining one or more outputs of the first machine-learning model, wherein the one or more obtained outputs indicate the title for the first content segment;
providing the one or more obtained outputs of the first machine-learning model as input to a second machine-learning model trained to predict a title quality for a predicted title;
obtaining one or more outputs of the second machine-learning model indicative of the title quality of the title for the first content segment; and
responsive to determining that the one or more outputs of the second machine-learning model satisfies a threshold criterion, providing the media item, an indication of each content segment and a respective title of each content segment for presentation to at least one user of the one or more users.

10. The system of claim 9, wherein the operations further comprise:
associating each content segment with a segment start indicator for a timeline of the media item.

11. The system of claim 9, wherein the input to the machine-learning model comprises a text string generated from at least one of a media item title, a content segment title, a content segment index, a number of content segments of the media item, or audio transcription data.

12. The system of claim 9, wherein the operations further comprise:
applying one or more filters to the one or more obtained outputs of the machine-learning model; and
responsive to the one or more obtained outputs failing to satisfy at least one condition of the one or more filters, discarding the one or more outputs.

13. (canceled)

14. The system of claim 9, wherein the operations further comprise:
detecting that the at least one user of the one or more users has engaged with a user interface (UI) element of a UI provided to a client device associated with the at least one user by the platform, wherein the UI element corresponds to a segment start indicator associated with the first content segment having the provided title; and
initiating playback of the first content segment associated with the segment start indicator and having the provided title via the client device.

15. The system of claim 9, wherein the media item is identified responsive to a request from a client device associated with a creator of the media item to provide user access to the media item via the platform.

16. The system of claim 9, wherein the media item comprises at least one of a video item or an audio item.

17. A non-transitory computer readable storage medium comprising instructions for a server that, when executed by a processing device, cause the processing device to perform operations comprising:
identifying a media item to be provided to one or more users of a platform, the media item having a plurality of content segments comprising a first content segment and a second content segment preceding the first content segment in the media item;
providing the first content segment and a title of the second content segment as input to a first machine-learning model trained to predict a title for the first content segment that is consistent with the title of the second content segment;
obtaining one or more outputs of the first machine-learning model, wherein the one or more obtained outputs indicate the title for the first content segment; and
providing the one or more obtained outputs of the first machine-learning model as input to a second machine-learning model trained to predict a title quality for a predicted title;
obtaining one or more outputs of the second machine-learning model indicative of the title quality of the title for the first content segment; and
responsive to determining that the one or more outputs of the second machine-learning model satisfies a threshold criterion, providing the media item, an indication of each content segment and a respective title of each content segment for presentation to at least one user of the one or more users.

18. The non-transitory computer readable storage medium of claim 17, wherein the operations further comprise:
applying one or more filters to the one or more obtained outputs of the machine-learning model; and
responsive to the one or more obtained outputs failing to satisfy at least one condition of the one or more filters, discarding the one or more outputs.

19. (canceled)

20. The non-transitory computer readable storage medium of claim 17, wherein the operations further comprise:
detecting that the at least one user of the one or more users has engaged with a user interface (UI) element of a UI provided to a client device associated with the at least one user by the platform, wherein the UI element corresponds to a segment start indicator associated with the first content segment having the provided title; and
initiating playback of the first content segment associated with the segment start indicator and having the provided title via the client device.
